(19) United States
(12) Patent Application Publication
(10) Pub. No.: US 2011/0195604 A1
(43) Pub. Date: Aug. 11, 2011

(54) ELECTRICAL CONNECTOR FOR TEST PURPOSE

(75) Inventor: HAN-MING ZHANG, Shenzhen (CN)

(73) Assignee: HON HAI PRECISION INDUSTRY CO., LTD., New Taipei (TW)

(21) Appl. No.: 13/014,795

(22) Filed: Jan. 27, 2011

(30) Foreign Application Priority Data
Feb. 8, 2010 (CN) 201020302522.4

(51) Int. Cl. H01R 13/70; H01R 24/00

(52) U.S. Cl. 439/620.21; 439/626

(57) ABSTRACT

An electrical connector (100) includes an insulative housing (1) and a switch unit (2) assembled in the insulative housing. The insulative housing defines a receiving space (121). The switch unit includes a first contact (21) and a second contact (22) extending parallel to the first contact. Each of the first contact and the second contact has a retaining portion (210, 220), a soldering portion (211, 221), and a flexible beam (212, 222) extending into the receiving space. A first flexible beam (212) of the first contact has a first contacting portion (215) bending laterally and connecting with a second flexible beam (222) of the second contact. The second flexible beam (222) of the second contact has a second contacting portion (225) bending laterally opposite to the first contacting portion and connecting with the first flexible beam (212) of the first contact.

### BACKGROUND OF THE INVENTION

1. Field of the Invention

The present invention relates generally to an electrical connector, and more particularly to an electrical connector for test purpose.

2. Description of Related Arts

U.S. Pat. No. 5,693,924 issued to Fetterolt et al. on Dec. 2, 1997, discloses a RF switch connector comprising an insulative housing, and a switch contact received in the insulative housing. The switch contact comprises a first contact arm and a second contact arm located below the first contact arm. The first contact arm includes a first, intermediate shank portion, a first, upwardly turned mating end, and a first solder tail formed generally at a 90 degree angle to said first shank portion. Furthermore, a contact extension projects perpendicularly from said first shank portion towards the second contact arm. The second contact arm includes a second mating end, where such second mating end exhibits a reversely bend portion, a second, intermediate shank portion, and a second solder tail, where such second solder tail is generally formed at about a 90 degree angle to said second shank portion. The first contact arm and the second contact arm are preset to be in intimate contact, namely the contact extension against the second shank portion. As a mating connector enters, the second mating end is pushed downwardly, namely the second contact arm separates away from the first contact arm. The RF switch connector has only one contact extension connecting with the second contact arm.

Hence, an electrical connector having more than one contact extension for conducting a better test is desired.

### SUMMARY OF THE INVENTION

Accordingly, an object of the present invention is to provide an electrical connector having more than one contact extension for conducting a better test.

To achieve the above object, an electrical connector includes an insulative housing and a switch unit assembled in the insulative housing. The insulative housing defines a receiving space. The switch unit includes a first contact and a second contact extending to with the first contact. Each of the first contact and the second contact has a retaining portion, a soldering portion, and a flexible beam extending into the receiving space. A first flexible beam of the first contact has a first contacting portion bending laterally and connecting with a second flexible beam of the second contact. The second flexible beam of the second contact has a second contacting portion bending laterally opposite to the first contacting portion and connecting with the first flexible beam of the first contact.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of an electrical connector constructed in accordance with the present invention;

FIG. 2 is another perspective, assembled view of the electrical connector;

FIG. 3 is a perspective, exploded view of the electrical connector; and

FIG. 4 is a cross-sectional view of the electrical connector.

### DETAILED DESCRIPTION OF THE PREFERRED EMBODIMENT

Reference will now be made in detail to the preferred embodiment of the present invention.

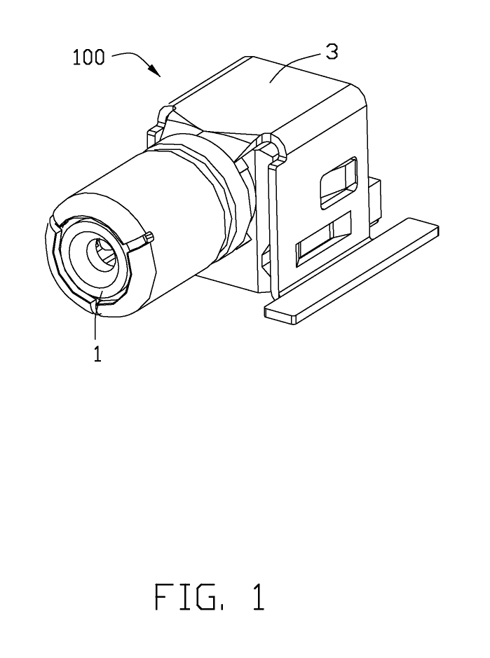

Referring to FIGS. 1-4, an electrical connector 100 in accordance with the present invention, used for testing a mating connector (not shown), comprises an insulative housing 1, a switch unit 2 received in the insulative housing 1, and a metallic shell 3 covering the insulative housing 1.

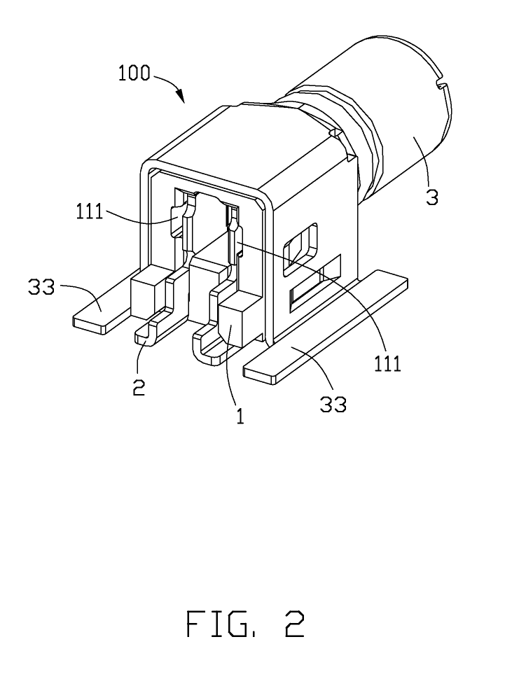

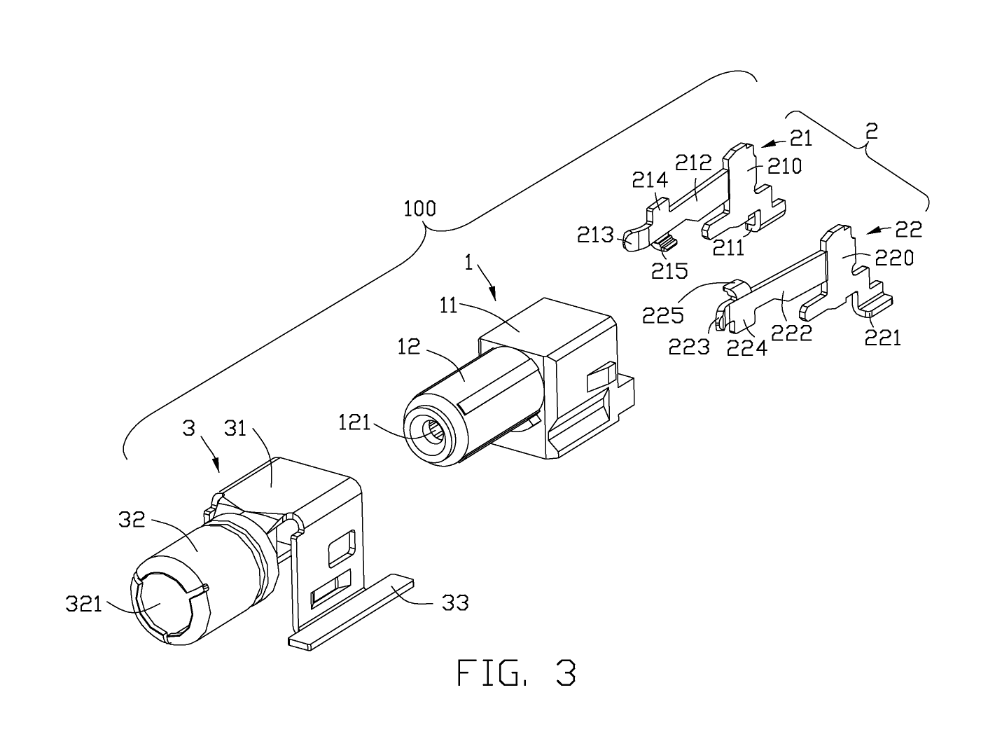

Referring to FIGS. 2 and 3, the insulative housing 1 comprises a base portion 11 and a casing portion 12 extending forwardly from the base portion 11. The base portion 11 defines a pair of passageways 111. The casing portion 12 defines a receiving space 121 communicating with the passageways 111. The metallic shell 3 comprises a frame portion 31 covering the base portion 11, an annular portion 32 extending forwardly from the frame portion 31 and shielding the casing portion 12, and a pair of soldering pads 33 extending laterally, downwardly from the frame portion 31 for soldering a printed circuit board (not shown). The annular portion 32 defines an aperture 321 and the aperture 321 encircles the receiving space 121. The mating connector is inserted into the receiving space 121 through the aperture 321 along a mating direction.

Referring to FIGS. 2-4, the switch unit 2 comprises a first contact 21 and a second contact 22. The first contact 21 and the second contact 22 are assembled in the passageways 111 of the insulative housing 1, being disposed along a left-and-right direction perpendicular to the mating direction. The first contact 21 comprises a first retaining portion 210, a first soldering portion 211 bending laterally, downwardly from the first retaining portion 210, and a first flexible beam 212 extending forwardly from the first retaining portion 210. The second contact 22 comprises a second retaining portion 220, a second soldering portion 221 bending laterally, downwardly from the second retaining portion 220, and a second flexible beam 222 extending forwardly from the second retaining portion 220. The second soldering portion 221 extends oppositely relative to the first soldering portion 211 along the left-and-right direction. The first flexible beam 212 and the second flexible beam 222 extend parallel with each other along the mating direction. The first flexible beam 212 forms a first guiding portion 213 at a free end thereof. The second flexible beam 222 forms a second guiding portion 223 at a free end thereof. The first guiding portion 213 and the second guiding portion 223 extend outwardly with respect to each other for guiding the mating connector. The guiding portions 213, 223 are respectively positioned at opposite sides of the receiving space 121 relative to an axis along the mating direction. A first confronting portion 214 extends upwardly from the first flexible arm 212 and a first contacting portion 215 bends rightward from the first flexible arm 212. A second confronting portion 224 extends downwardly from the second flexible arm 222 and a second contacting portion 225 bends leftward from the second flexible arm 222. The first confronting portion 214 and the first contacting portion 215 are formed at opposite sides of the first flexible arm 212 along a vertical direction perpendicular to both the mating direction and the left-and-right direction. So does the second confronting portion 224 and the second contacting portion 225. The second confronting portion 224 and the second contacting portion 225 are also formed at opposite sides of the second flexible arm 222 along the vertical direction.

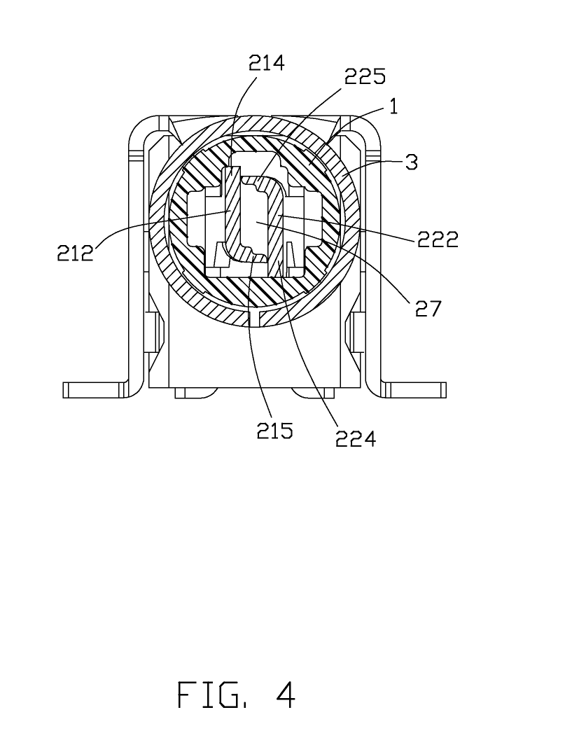

Referring to FIG. 4, the first flexible beam 212 and the second flexible beam 222 both extend into the receiving space 121 of the insulative housing 1. In an initiate position, the first contacting portion 215 connects the second confronting portion 224 and the second contacting portion connects the first confronting portion 214. All of the first confronting portion 214, the first contacting portion 215, the second confronting portion 224, and the second contacting portion 225 cooperatively define a gap 27. The gap 27 communicates with the aperture 321 for receiving the mating connector. When the mating connector is inserted, the mating connector deflects one of the first flexible beam 212 and the second flexible beam 222, and the first contacting portion 215 disconnects the second confronting portion 224 and the second contacting portion disconnects the first confronting portion 214. Accordingly, a purpose for testing the mating connector is achieved.

In the present invention, because the switch unit 2 has two contacting portions 215, 225, the connection between the first contact 21 and the second contact 22 is reliable.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector comprising:
an insulative housing defining a receiving space; and
a switch unit assembled in the insulative housing and comprising:
a first contact having a first retaining portion, a first soldering portion, and a first flexible beam extending into the receiving space; and
a second contact extending parallel to the first contact, the second contact having a second retaining portion, a second soldering portion, and a second flexible beam extending into the receiving space; wherein
the first flexible beam has a first contacting portion bending laterally and connecting with the second flexible beam, and the second flexible beam has a second contacting portion bending laterally opposite to the first contacting portion and connecting with the first flexible beam.

2. The electrical connector as claimed in claim 1, wherein the first and the second flexible beams extend along a mating direction, and the first and the second contacting portions extend along a left-and-right direction perpendicular to the mating direction.

3. The electrical connector as claimed in claim 2, wherein the first flexible beam has a first confronting portion and the second flexible beam has a second confronting portion extending opposite to the first confronting portion, the first confronting portion connects with the second contacting portion, and the second confronting portion connects with the first contacting portion.

4. The electrical connector as claimed in claim 3, wherein the first and the second confronting portions extend along a vertical direction perpendicular to both the mating direction and the left-and-right direction.

5. The electrical connector as claimed in claim 3, wherein the first contacting portion, the first contacting portion, the second contacting portion, and the second contacting portion cooperatively define a gap.

6. The electrical connector as claimed in claim 5, further comprising a metallic shell covering the insulative housing, and wherein the metallic shell defines an aperture communicating with the gap.

7. The electrical connector as claimed in claim 6, wherein the insulative housing comprises a base portion and a casing portion, the metallic shell comprises a frame portion covering the base portion and an annular portion shielding over the casing portion.

8. The electrical connector as claimed in claim 7, wherein the receiving space is defined by the casing portion and the aperture is defined by the annular portion.

9. The electrical connector as claimed in claim 8, wherein the aperture encircles the receiving space.

10. The electrical connector as claimed in claim 2, wherein each of the first and the second flexible arms forms a guiding portion at a free end thereof.

11. The electrical connector as claimed in claim 10, wherein the guiding portions are respectively positioned at opposite sides of the receiving space relative to an axis along the mating direction.

12. An electrical connector for mating with a plug, comprising:
an insulative housing defining a plug receiving hole, along a front-to-back direction, with a pair of contact passageways by two sides in a transverse direction perpendicular to said front-to-back direction;
a pair of contacts disposed in the corresponding passageways, respectively, and having a similar configuration in a side view, each of said contacts defining a forwardly extending deflectable arm with a main body essentially in primarily a vertical plane while toward the other, an outward and forwardly curved section located at a front end to cooperate with that of the other arm to form an enlarged opening for guiding insertion of a terminal of the plug into the plug receiving hole, a confrontation tab extending from a side edge of said main body essentially in a coplanar manner under condition that the confrontation tabs of the two deflectable arms extend from differently leveled side edges of the corresponding main bodies and in opposite to each other in a vertical direction perpendicular to both said front-to-back direction and said transverse direction, and a contact tab extending from the other side edge of the main body under condition that the contact tabs of the two deflectable arms extend from differently leveled side edge of the corresponding main bodies and toward the main body of the other deflectable arm so that the contacting tabs and the main bodies of the two deflectable arms commonly define a restricted space for receiving the terminal of the plug.

13. The electrical connector as claimed in claim 12, wherein the contacting tab of one deflectable arm contacts the other deflectable arm in the transverse direction.

14. The electrical connector as claimed in claim 12, wherein the confrontation tab of the deflectable arm abuts against the housing in the vertical direction.

15. The electrical connector as claimed in claim 12, wherein the pair of contacts further include solder tail extending from bottom edges thereof and outwardly and horizontally bent away from each other.

16. The electrical connector as claimed in claim 12, further including a metallic shell enclosing the housing wherein said shell further includes two opposite mounting flanges horizontally and outwardly extending away from each other.
